(19) United States
(12) Patent Application Publication
(10) Pub. No.: US 2009/0207175 A1
(43) Pub. Date: Aug. 20, 2009

(54) Animation Using Animation Effect and Trigger Element

(75) Inventor: Peter R. Warner, Paris (FR)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/032,210

(22) Filed: Feb. 15, 2008

(51) Int. Cl. G06T 13/00

(52) U.S. Cl. 345/473

(57) ABSTRACT

Among other disclosed subject matter, a computer-implemented method for animating an image element includes determining that a trigger element defined by a trigger element occurs. The method includes, in response to the trigger element, applying an animation effect to a group that comprises at least one image element. A first association between the animation effect and the group is configured for another animation effect to selectively be associated with the group, and a second association between the trigger element and the animation effect is configured for another trigger element to selectively be associated with the animation effect.

### TECHNICAL FIELD

This document relates to an animation using an animation effect and a trigger element.

### BACKGROUND

Moving images are sometimes provided by defining some property of an animation and selectively applying that animation to a picture or other image. This can then cause the image or picture to move, such as on a computer screen. Such animation are sometimes implemented in a hard-coded fashion, whereby there is little or no flexibility in modifying the way the animation works and/or what it is applied to.

Certain approaches can be used, say, when there are multiple instances of an image that are to appear in a view, such as individual raindrops that are to illustrate a rainfall. In such implementations, the appearance of individual droplets is sometimes effectuated by defining a birth rate of raindrops for the area at issue. That is, some entity such as a user, a random number generator or another application can specify the birth rate variable and this data causes the appropriate number of raindrop instances to be included in the view. When the animation is displayed, then, a viewer sees the specified number of raindrops appearing on the screen.

### SUMMARY

The invention relates to animating one or more image elements.

In a first aspect, a computer-implemented method for animating an image element includes determining that a trigger event defined by a trigger element occurs. The method includes, in response to the trigger event, applying an animation effect to a group that comprises at least one image element. A first association between the animation effect and the group is configured for another animation effect to selectively be associated with the group, and a second association between the trigger element and the animation effect is configured for another trigger element to selectively be associated with the animation effect.

Implementations can include any, all or none of the following features. The image element can be at least one of: an image of an object, a character, and combinations thereof. The trigger element can lack spatial properties and include information configured to feed a parameter to the animation effect regarding the image element. The information can be contained in at least one of: a numerical list, an alphabetical list, a random list, an amplitude of audio, input generated using an input device, input generated using a touch screen, and combinations thereof. The trigger element can have at least one spatial property and can be configured to feed a parameter to the animation effect regarding the image element, the trigger element triggering the animation effect upon touching the image element. The trigger element can be one of: a geometric figure, a circle, a line, an animated sequence, and combinations thereof. The trigger element can include a standard zone that causes the animation effect to be applied, and a dropoff zone that causes the animation effect to be applied to a lesser degree than in the standard zone. The method can further include changing the spatial property. The changing spatial property can be one of: a shape changing size, a moving line, and combinations thereof. The spatial property can change in response to a user manipulating the spatial property. The group can include multiple image elements that are currently in an ordered state, and applying the animation effect can cause each of the multiple image elements to undergo motion away from the ordered state. The motion can be one of: motion with inertia applied to the multiple image elements, and motion without inertia applied to the multiple image elements. The animation effect can cause the image element to rotate. The animation effect can include a wind effect that gives an appearance of blowing on the image element. The animation effect can include a fire effect that gives an appearance of burning the image element. The animation effect can cause one of: a size of the image element to change, a color of the image element to change, and combinations thereof. Multiple animation effects can be associated with the group, each of the animation effects having a particular trigger element.

In a second aspect, a computer program product is tangibly embodied in a computer-readable storage medium and includes instructions that when executed by a processor perform a method for animating an image element. The method includes determining that a trigger event defined by a trigger element occurs. The method includes, in response to the trigger event, applying an animation effect to a group that comprises at least one image element. A first association between the animation effect and the group is configured for another animation effect to selectively be associated with the group, and a second association between the trigger element and the animation effect is configured for another trigger element to selectively be associated with the animation effect.

In a third aspect, a computer-implemented method for providing animation of an image element includes obtaining a group comprising at least one image element that is to be animated. The method includes generating a first association for an animation effect to be applied to the obtained group, the first association being configured for another animation effect to selectively be associated with the obtained group. The method includes generating a second association for a trigger element to trigger the animation effect, the second association configured for another trigger element to selectively be associated with the animation effect.

Implementations can include any, all or none of the following features. The method can further include associating the other animation effect with the obtained group, wherein the other animation effect is to be triggered at least by the trigger element. The method can further include associating the other trigger element with the animation effect, wherein the animation effect is to be triggered at least by the other trigger element.

In a fourth aspect, a computer program product is tangibly embodied in a computer-readable storage medium and includes instructions that when executed by a processor perform a method for providing animation of an image element. The method includes obtaining a group comprising at least one image element that is to be animated. The method includes generating a first association for an animation effect to be applied to the obtained group, the first association being configured for another animation effect to selectively be associated with the obtained group. The method includes generating a second association for a trigger element to trigger the animation effect, the second association configured for another trigger element to selectively be associated with the animation effect.

Implementations can provide any, all or none of the following advantages. A more flexible animation can be provided. An animation can be provided that includes a freely interchangeable animation effect to be applied to an image element. An animation can be provided that includes a freely interchangeable trigger element to initiate an animation effect for an image element. An animation can be provided where both an animation effect and respective a trigger element are freely interchangeable.

The details of one or more embodiments are set forth in the accompanying drawings and the description below. Other features and advantages will be apparent from the description and drawings, and from the claims.

### DESCRIPTION OF DRAWINGS

FIG. 1 is a block diagram conceptually showing a combination including associations that can be used to animate at least one image element.

FIGS. 2A-2C are screenshots of an example animation using a circular trigger element, a displacement animation effect, and character-based image elements.

FIGS. 3A-3B are screenshots of an example animation using line trigger elements, a simulated wind animation effect, and character-based image elements.

FIGS. 3C-3D are screenshots of an example animation using a circular trigger element, a magnification animation effect, and character-based image elements.

FIGS. 4A-4B are screenshots of an example animation using an image-based trigger element, a displacement animation effect, and character-based image elements.

FIGS. 5A-5D are screenshots of an example animation using line trigger elements, an ordering animation, and image-based image elements.

FIGS. 6A-6C are screenshots of an example animation using line trigger elements, an ordering animation, and image-based image elements.

FIGS. 7A-7C are screenshots of an example animation using multiple circular trigger elements, multiple drop-off zones, a blurring animation effect, and character-based image elements.

FIGS. 8A-8C are screenshots of an example animation using line triggers, a reshuffling animation effect, and character-based image elements.

FIGS. 9A-9D are screenshots of an example animation using multiple circular trigger elements, multiple animation effects, and character-based image elements.

FIG. 10 is a screenshot of an example animation using touch screen-based trigger element, a displacement animation effect, and image-based image elements.

FIG. 11 is a flow chart of a method for animating an image element.

FIG. 12 is a flow chart of a method for providing animation of an image element.

FIG. 13 is a block diagram of a computing system that can be used in connection with computer-implemented methods described in this document.

Like reference symbols in the various drawings indicate like elements.

### DETAILED DESCRIPTION

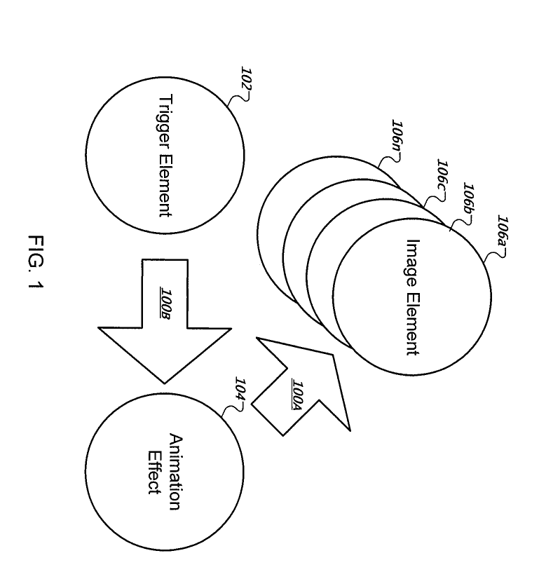

FIG. 1 is a block diagram conceptually showing a combination including associations 100A-B that can be used to animate at least one image element 106a-106n. One or more animation effects 104 can be applied to at least one image element 106a-106n using the association 100A to generate a corresponding animation on a display device. Image elements 106a-106n can include any kind of element that can be represented visually, including images of objects and character strings, to name two examples. Here, image elements 106a-106n are organized in an ordered group. An ordered group is any series of elements (e.g., image elements) that are related to each other in some fashion. Ordered groups can include text, particles generated from a particle system, a stack of combined images, multiple copies of an image element, or a collection of bush strokes, to name a few examples. For example, a particle system can be configured to generate a number of particles including a first particle, a second particle, and so on, where the particles can be ordered according to when they are generated.

At least one trigger element 102 can be applied to the animation effect 104 using the association 100B to specify when and/or where the animation effect 104 occurs. In some implementations, trigger elements 102 can include some information that is provided to the animation effects 104 to animate the image elements 106a-106n. Trigger elements 102 can lack spatial properties. Trigger elements 102 that lack spatial properties include a numeric list, an alphabetical list, a random list, and an amplitude of audio, to name a few examples. For example, amplitude values of an audio sample can be provided as one or more parameters for the animation effects 104. As another example, one or more values can be retrieved from a list of values and used as parameters for the animation effects 104. Such parameters can specify the order in which each of several image elements are triggered, to name just one example.

In other implementations, trigger elements 102 can have spatial properties. Trigger elements 102 with spatial properties include a circle, a line, or other geometric figures, to name a few examples. In some implementations, the magnitude of the effect can be determined from parameters provided by the trigger elements 102. A trigger element can be visible or not visible to a user, regardless of whether the element extends spatially. For example, the implementations that will be described in connection with some of the figures in the present disclosure have trigger elements shown for clarity. In an actual implementation, such trigger elements can be invisible.

These spatial trigger elements 102 can activate the animation effects 104 when the trigger elements 102 touches at least one image element 106a-106n. For example, as a circular trigger element touches one or more image elements 106a-106n, the image elements that are touched are deformed (e.g., blurred, scaled, rotated, and the like) according to the animation effects 104 with a magnitude of the effect corresponding to the parameters of the circular trigger element 102.

The associations 100 are configured so that the items they connect are interchangeable. For example, any trigger element 102 can provide parameters to any animation effect 104 using the association 100B, and any animation effect 104 can be activated by any trigger element 102. For example, a new trigger element can be associated with the animation effect 104 without affecting the animation effect 104 or its association 100A with the image elements. As another example, a user can associate new images elements to be animated by the animation effect 104 without affecting the trigger element 102. This can provide a user flexibility when defining and/or associating trigger elements 102, animation effects 104, and image elements 106a-106n. For example, combinations of a few of the many trigger elements 102 animation effects 104, and image elements 106a-106n that use associations 100A-B are described in more detail below.

Trigger elements 102 can be configured to change during run-time execution. For example, a geometric figure (e.g., a circle) can change in size, thus determining when it will trigger the animation of particular image elements. In some implementations, the trigger element 102 can be manipulated by the actions of a user during run-time execution. The user can provide user input through a keyboard, mouse, pointing device, or other user input device to modify the size of a geometric shape or change the speed of a moving line, to name a few examples. For example, the user can use a scroll wheel on a mouse to modify the size of a circular trigger element 102 or modify the speed of a line trigger element 102.

In some implementations, the trigger elements 102 can be configured with one or more drop-off zones. In general, drop-off zones allow trigger elements to gradually increase or decrease the magnitude of the parameters provided to the animation effects 104 during run-time execution. For example, the amount of blur applied to the image elements 106a-106n can gradually change corresponding to a change in magnitudes provided by one or more trigger elements 102. Drop-off zones are described in more detail in reference to 7A-7C.

In some implementations, the trigger elements 102 can be an animated movie clip or other animated representations, to name two examples. These animated trigger elements 102 can interact with image elements 106a-106n in a substantially similar manner to other ones of the trigger elements 102 that have spatial properties. In other words, as the animated trigger elements 102 touch the image elements 106a-106n they trigger appropriate animation effects 104. Thus, both the item that the animation effect is applied to (i.e., the image element(s) 106) and the trigger that causes the animation to occur (i.e., the trigger element 102) can include an animated image. In addition, in some implementations, the animated trigger elements 102 can move in a manner consistent with their respective animation. For example, an animated trigger element that applies to an image of a football player may move in a direction consistent with the football player image. That is, if the football player's animation is oriented in a particular direction, the trigger element can also move in that direction.

Animation effects 104 can be configured to provide one or more image processing functions to any of the image elements 106. Image processing functions can change the position, size, color, orientation, or provide a filter (e.g., blurring) to modify at least one image element 106a-106n, to name a few examples. For example, the animation effects 104 can push the one or more portions of image elements 106a-106n away from each other using inertia or residual motion, to name two examples. The animation effects 104 may be an activation of a simulation. For example, a text string may blow away like leaves in the wind, or fall with a simulation of gravity. As another example, animation effects 104 may also be a conversion of image elements 106a-106n into particles. In addition, multiple animation effects 104 can be combined to generate additional animation effects. For example, a particle system effect can be combined with a wind simulation effect to move the generated particles according to the wind simulation. Particles (i.e., snowflakes, raindrops, fire elements, a flock of fairies) can be visually random, but may be based on an ordered list because the computer internally knows the number and position of each individual particle. Once started by a trigger element 102, certain animation effects are continuous, unless they are discontinued be another trigger element 102, user input, or some other event, to name a few example. Some continuous animation effects include wind simulations, gravity simulations, particle systems, magnification animations, and blurring animations, to name a few examples.

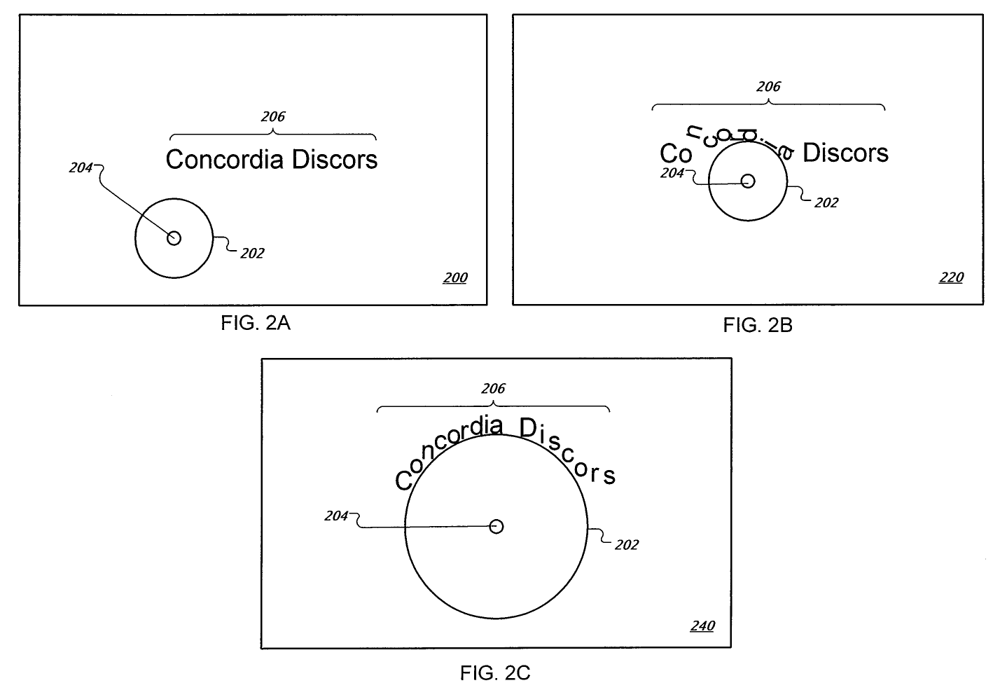

FIGS. 2A-2C are screenshots 200, 220, and 240, respectively, of an example animation using a circular trigger element 202, a displacement animation effect, and character-based image elements 206. As illustrated by FIG. 2A, image elements 206 in this example are sixteen individual characters that together form the words “Concordia Discors.” That is, each character in the string is here a separate element of the ordered group that comprises the image elements 206. In other implementations, more than one character can be included in an image element.

The trigger element 202 may move according to received user input. For example, the user can position a pointing device (e.g., a mouse) on or near user interface element 204, click a mouse button, and move the trigger element 202. As another example, the user can provide keyboard input (e.g., pressing one or more arrow keys) to move the trigger element 202. In other implementations, the motion of the trigger element 202 can be determined other than by user input, such as by being associated to a fluctuating variable or being randomized.

As illustrated by FIG. 2B, as the trigger element 202 touches any of the image elements 206, the image elements touched by the trigger element 202 are displaced. That is, it can be seen that some letters are being oriented differently and some have left their original positions. For example, the inertia of trigger element 202 imparted by the user when moving the trigger element 202 provides parameters corresponding to the magnitude of the displacement for the animation effect.

As illustrated by FIG. 2C, the user can also increase the size of the trigger element during run-time operation. For example, the user can select an edge of the trigger element 202 (e.g., by clicking a mouse button or some other combination of user inputs) and then drag the mouse. In response, the trigger element 202 changes in size. For example, the trigger element 202 can grow in size or shrink in size. This change in size can change the number of image elements 206 that are touching the trigger element 202. For example, because the trigger element 202 has grown in size, the animation effect is applied to all of the image elements 206 touching the enlarged trigger element 202. It can be seen that the individual characters in FIG. 2C are displaced a greater distance, but remain relatively less rotated, than the characters in FIG. 2B.

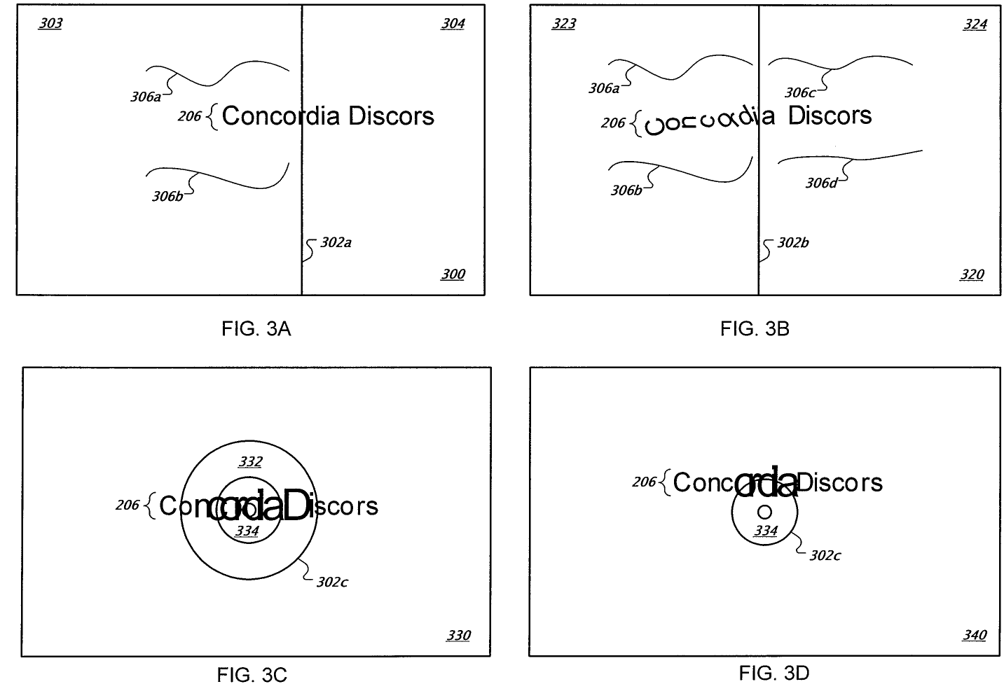

FIGS. 3A-3B are screenshots 300 and 320, respectively, of an example animation using line trigger elements 302a and 302b, a simulated wind animation effect, and character-based image elements 206. Here, the elements 302a and 302b are lines that move from left to right in the view, with the element 302a before the element 302b.

Because the trigger element 302a includes spatial properties (i.e., it is a line), the trigger element 302a can be configured to provide parameters to the animation effect corresponding to the spatial properties. For example, every image element to the left of the line 302a (e.g., in region 303) is affected by the simulated wind animation effect, as illustrated by representations of wind 306a and 306b, respectively. In addition, every image element to the right of the trigger element 302a (e.g., in region 304) is not affected by the simulated wind animation effect. The wind animation effect triggered by the element 302a can cause the letters to jiggle, but in this example is not strong enough to completely relocate any letter from its original position.

As illustrated by FIG. 3B, another line trigger 302b following after the element 302a is used to modify the magnitude of the simulated wind animation effect. For example, in region 323 the magnitude of the wind simulation has increased resulting in a portion of image elements 206 that are animated to fly away. As another example, in region 324, the magnitude of the simulation has not yet increased, resulting in a portion of image elements 206 appearing substantially similar to those in region 304. However, as illustrated by wind lines 306a-306d, the previous animation effect as specified by the parameters of trigger element 302a shown in screenshot 300 is still animated. In some implementations, the line triggers 302a and 302b may be two separate trigger elements 102. For example, after line trigger 302a has moved across the view, a user can replace the line trigger 302a with line trigger 302b. Line trigger 302b can then move across the view increasing the magnitude of the simulated wind animation effect, generating an animation of blowing image elements 206. In other implementations, the line trigger's parameters can be modified during run-time execution to change the magnitude of the simulated wind animation effect. For example, the user can change the parameters of line trigger 302a to generate an increased magnitude of the animation effect. Then when the reconfigured line trigger 302b moves across the view, the simulated wind animation effect animates the image elements 206 as shown in screenshot 320.

FIGS. 3C-3D are screenshots 330 and 340, respectively, of an example animation using a circular trigger element 302c, a magnification animation effect, and character-based image elements 206. As illustrated by FIG. 3C, the trigger element 302c has two regions: a drop-off region 332 and a magnification region 334. Any image element touching the magnification region (such as by abutting the edge of the magnification region or by being at least partially covered by the magnification region) can be magnified by a specified amount, as illustrated with the letters in FIG. 3C. The drop-off region 332 has a gradually reduced magnitude of the magnification animation effect compared to the magnification region 334. For example, image elements 206 that are further inside the drop-off region (i.e., closer to the magnification region 334) can be magnified larger than image elements that are closer to the outer edge of drop-off region 332. Image elements that are not touched by trigger element 302c can remain at their previous size.

As illustrated by FIG. 3D, the drop-off region 332 can be omitted or removed, such as by a user during run-time execution. For example, the user can effectively shrink the drop-off region 332 to zero size by dragging the edge of the drop-off region onto the edge of the magnification region 334. As another example, the user can use a combination of one or more keystrokes or other user inputs to remove the drop-off region. The result of removing the drop-off region can be that only those image elements that are touching the trigger element 302c are magnified.

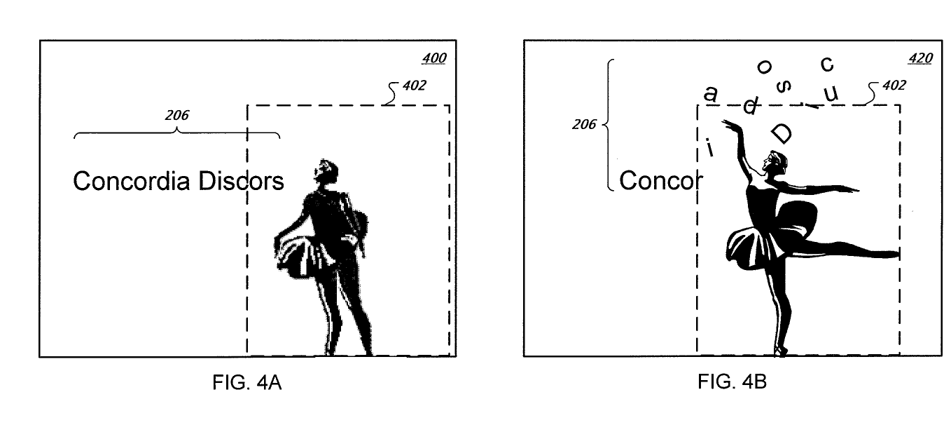

FIGS. 4A-4B are screenshots 400 and 420, respectively, of an example animation using an image-based trigger element 402, a displacement animation effect, and character-based image elements 206. In this example, an animated image of a dancing ballerina is used as the trigger for displacing the image elements 206. When an image-based trigger element 402 is used, one or more pixel values relating to the trigger element can be compared to determine if the image-based trigger element 402 touches the image elements 206 at least in part. If so, the animation effect can be performed on the image element.

In some implementations, the pixel values in the alpha channel are used to determine if the trigger element 402 is touching any of the image elements 206. For example, some portions of the image-based trigger element 402 are transparent (e.g., the pixels of the image corresponding to the background of the image). In other words, the alpha channel value for the background pixels is substantially zero. As another example, some portions of the image-based trigger element 402 are not transparent (e.g., the pixels corresponding to the ballerina). In other words, the alpha channel value for the pixels is not substantially zero. If, for example, pixels with an alpha channel value that is not substantially zero touch at least one of the image elements 206, the displacement animation effect is triggered. For example, as illustrated by FIG. 4B, the hand of the ballerina has displaced a portion of the image elements 206.

In some implementations, the movement speed of the image-based trigger element 402 can be used as a parameter for the displacement effect. For example, if the ballerina moves more slowly, the displacement effect may be reduced in magnitude. In some implementations, the movement speed of the trigger element 402 is determined by the animation speed corresponding to the animation used for the image-based trigger element 402. For example, if the animation speed of the dancing is increased, the trigger element 402 may move across the view at an accelerated rate. In other implementations, the movement speed of the trigger element 402 can be determined randomly, determined by an input parameter, or based on other user input, to name a few examples.

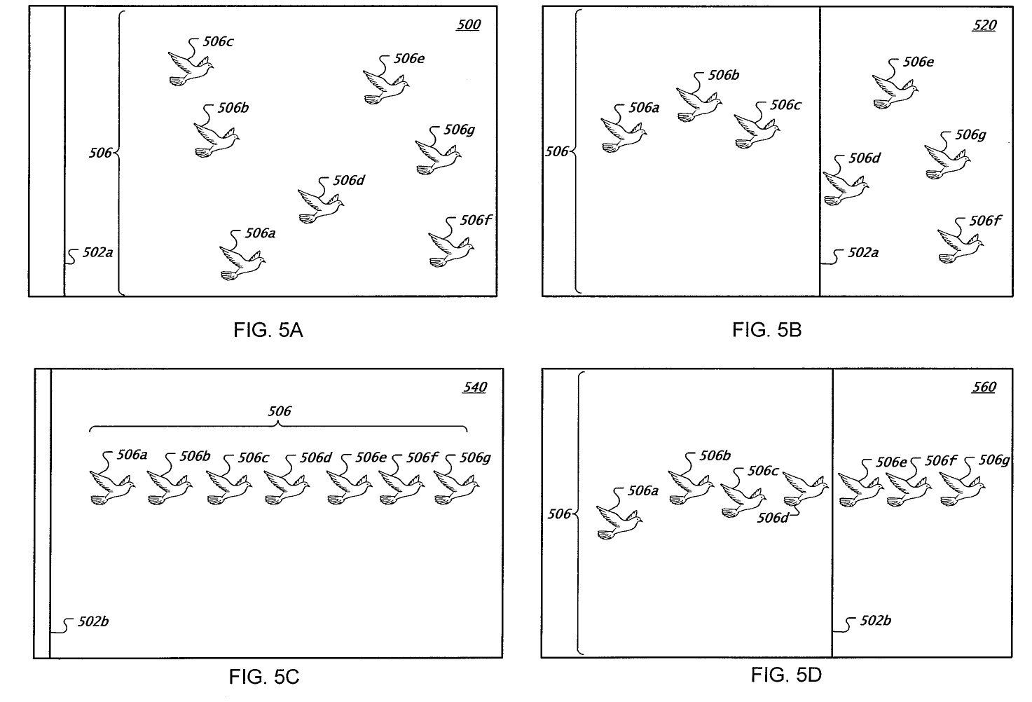

FIGS. 5A-5D are screenshots 500, 520, 540 and 560, respectively, of an example animation using line trigger elements 502a and 502b, an ordering animation effect, and image-based image elements 506. In this example, the image elements 506 appear as seven birds that may move within the view. Moreover, the trigger elements 502a and 502b are lines that move from left to right in the view, with the element 502a before the element 502b. In some implementations, the image elements 506 may move according to their own respective predefined animations. For example, the images elements 506 can move around the view using a flying animation. As illustrated by FIGS. 5A-5C, when trigger element 502a touches any of the image elements 506, the ordering animation effect animates the touched image element 506, eventually causing the image elements 506 to group in a straight line according to their order in the ordered group. For example, in FIG. 5C, the image elements 506 are sorted in the order 506a-506g. Accordingly, when they line up after successively being triggered by the line, they assume the order as sorted.

Some trigger elements can also stop an animation effect. For example, as illustrated in FIG. 5D, as trigger element 502b touches each of the image elements 506a-506g, the ordering animation effect stops, and the image elements 506 begin to move in a manner consistent with their own respective animation (e.g., flying off in different directions).

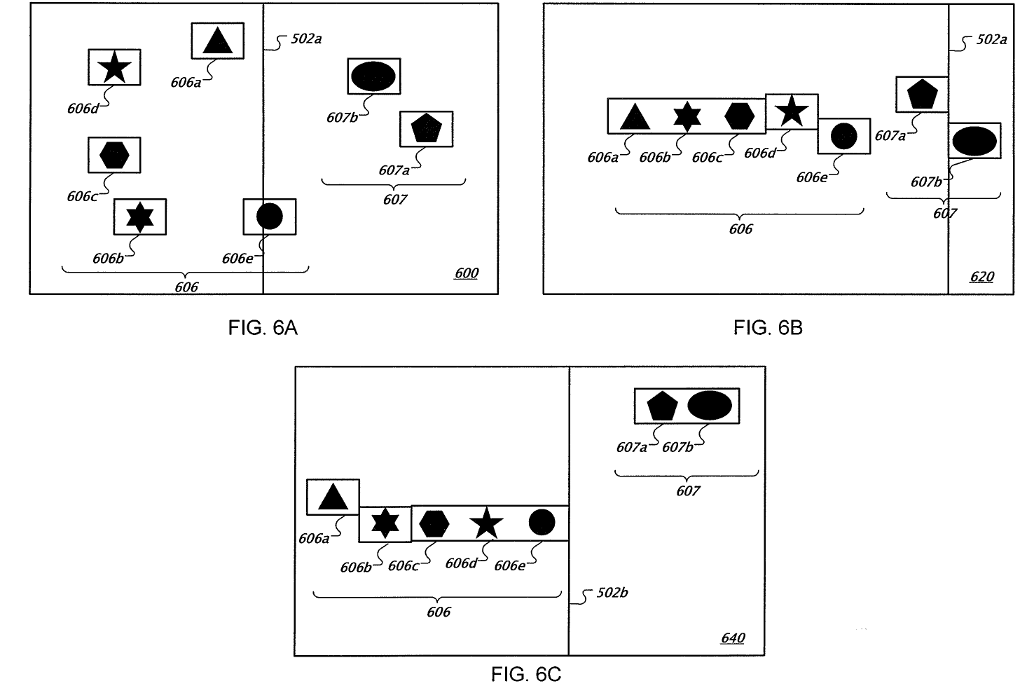

FIGS. 6A-6C are screenshots 600, 620, 640, respectively, of an example animation using line trigger elements 502a and 502b, an ordering animation effect, and image-based image elements 606 and 607. In this example, image-based elements 606 and 607 are split into ordered groups 606a-606e and 607a-607b, respectively. Each of the ordered group elements 606a-606e and 607a-607b may move within the view. In addition, the ordered groups 606a-606e and 607a-607b when combined can form an image according to the ordering of the image elements 606 and 607. Moreover, as illustrated by FIGS. 6A-6C, the same animation effect is here initiated by the triggers 502a and 502b with new image elements 606 and 607 without affecting the triggers 502a-502b the animation effect, or the associations therebetween. For example, trigger element 502a orders the image elements 606 and 607 based on the ordered groups 606a-606e and 607a-607b, respectively. As another example, trigger element 502b stops the ordering animation and members of the ordered groups 606a-606e and 607a-607b may move in different directions according to their predefined animations. In some implementations, the combination of image elements 606 and/or 607 may continue to move as a cohesive group consistent with their predefined animation. For example, as illustrated in FIG. 6C, because trigger element 502b has not yet come into contact with image element 607, image element 607 can move as a cohesive group according to its predefined animation. In other words, FIGS. 6A-C illustrate, compared to FIGS. 5A-D, that the same or similar triggering elements can activate the same or a similar animation effect to be applied to another set of image elements. Other variations can be used, such as to replace only the trigger element or only the animation effect.

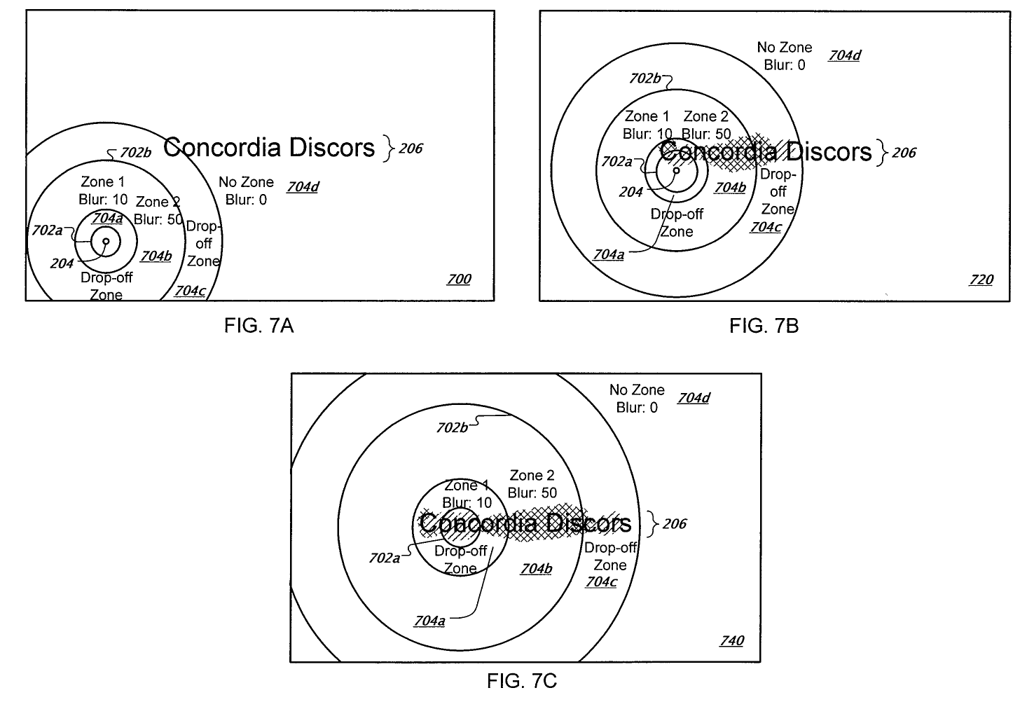

FIGS. 7A-7C are screenshots 700, 720, and 740, respectively, of an example animation using multiple circular trigger elements 702a and 702b, multiple drop-off zones 704a and 704c, a blurring animation effect, and character-based image elements 206. In this example, the multiple trigger elements 702a and 702b can be used to provide multiple parameters to the same animation effect. For example, when trigger 702a touches the image elements 206, the trigger element 702a provides a magnitude parameter value of 10 to the blurring animation effect. As another example, as shown in region 704b, when trigger element 702b touches the image elements 206, the trigger element 702b provides a magnitude parameter value of 50 to the blurring animation effect. In addition, as illustrated by FIGS. 7A-7C, these magnitude values can be modified by one or more drop-off zones 704a and 704c.

The drop-off zones 704a and 704c can allow a gradual change of magnitude of parameters provided to the animation effect. For example, trigger element 702a uses a blurring magnitude of 10, while trigger element 702b uses a blurring magnitude of 50. According to the differences between the blurring magnitudes of trigger elements 702a and 702b, drop-off zone 704a can gradually change the magnitude from 10 to 50. As another example, because region 704d does not include a blurring magnitude (e.g., the blurring magnitude is zero), the drop-off zone 704c gradually changes the blurring magnitude from 50 to zero, according to the differences in magnitude between trigger element 702b and region 704d, respectively. In some implementations, the drop-off zones can interpolate between the two values to determine an appropriate magnitude at a particular point in the drop-off zone. For example, because the inner edge of drop-off zone 704a has a blurring magnitude of 10, and the outer edge of drop-off zone 704a has a blurring magnitude of 50, drop-off zone 704a has a difference range of 40. If the drop-off zone 704a measures 40 units (e.g., mm, cm, inches, or some other unit of measurement) in size, than at every unit of measurement, the magnitude would change by a value of one, for example.

In addition, as illustrated by FIGS. 7B and 7C, the user can modify the size of any or all of the trigger elements 702a and 702b, the drop-off zones 704a and 704c, or both. For example, the user can click a mouse button and drag any of the edges of trigger elements 702a-702b and drop-zones 704a and 704c, or both, to modify the size of the respective area. In response, new magnitude parameters can be provided to the animation effect, which can modify the animation accordingly. For example, in FIG. 7B, the size of drop-off zone 704a has changed with modifies the rate of change for the corresponding blur magnitude parameter. As another example, in FIG. 7C, the size of all of the triggers 702a-702b and the drop-off zones 704a and 704c have increased with applies the blurring animation effect to more of the image elements 206.

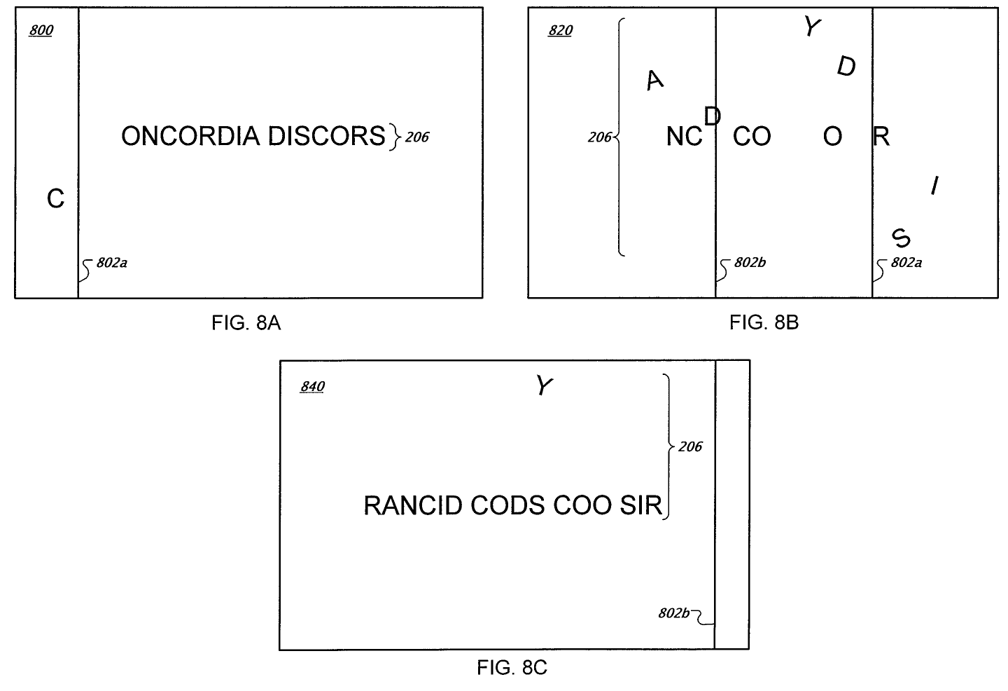

FIGS. 8A-8C are screenshots 800, 820 and 840, respectively, of an example animation using line triggers 802a and 802b, a reshuffling animation effect, and character-based image elements 206. In this example, the elements 802a and 802b are lines that move from left to right in the view, with the element 802a before the element 802b. The reshuffling animation can animate the image elements 206 to re-order the image elements 206. For example, line trigger 802a can break up the ordering between the characters in the phrase “CONCORDIA DISCORS”. As another example, line trigger 802b can apply a different re-ordering to the image elements 206 according to the ordering specified by the parameters of line trigger 802b. Here, the new order of the characters spells the phrase “RANCID CODS COO SIR”. In various implementations, animations can be simultaneously animated corresponding to the one or more parameters provided to the animation effect.

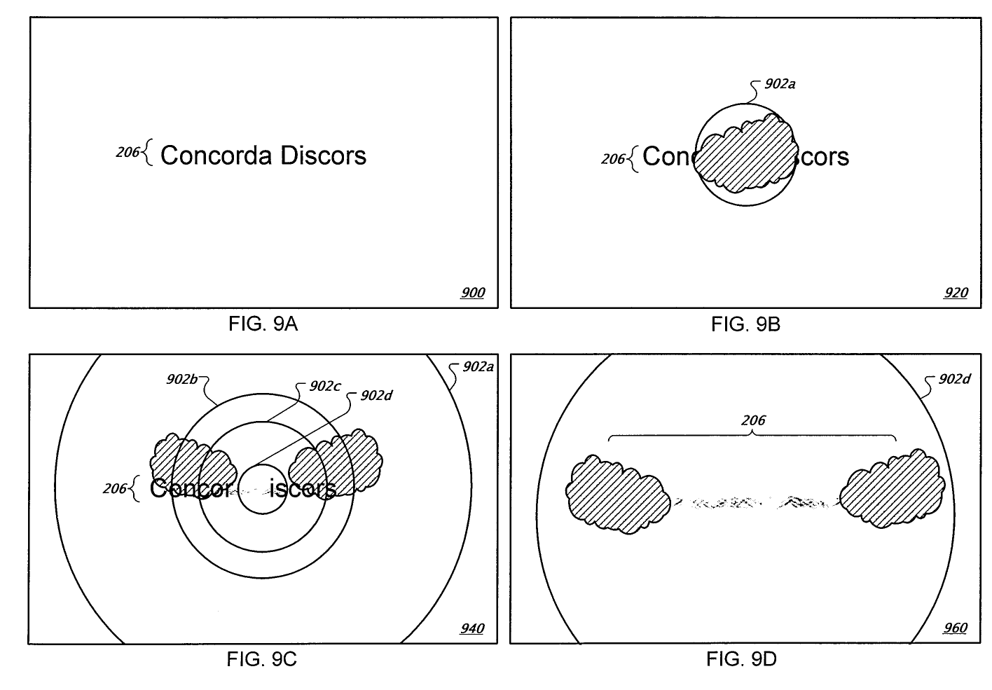

FIGS. 9A-9D are screenshots 900, 920, 940, and 960, respectively, of an example animation using multiple circular trigger elements 902a-902d, multiple animation effects, and character-based image elements 206. In this example, the trigger elements 902a-902d can be used to produce an animation effect of the image elements 206 appearing to burst into flames and disintegrate into a smoldering pile of ashes. In addition, trigger elements 902a-902d can be configured to move and/or change size corresponding to a time interval. For example, as illustrated in FIGS. 9B-9D, the radius of each of the triggers 902a-902d increases over time, causing the trigger to be applied to increasingly more of the image elements 206. In addition, trigger elements can be configured to start after a predetermined amount of time. For example, trigger element 902d can be configured to start after trigger element 902c. As another example, after a certain amount of time, trigger element 902b can start after trigger element 902c, and so on. This allows various different triggers to be strung together to provide parameters to different animation effects, allowing a user a high degree of customization when creating animations.

For example, in FIG. 9B, trigger 902a provides parameters for a particles system. The particle system generates flame particles that appear to interact with image elements 206. As another example, in FIG. 9C, trigger element 902b provides parameters for a filtered glowing edge to simulate cinders, and trigger element 902c stops the particle system and begins to shrink the height of the characters. In FIG. 9C and 9D, trigger element 902d emits smoke particles. The end result of the combination of trigger elements 902a-902d and animation effects provides an animation where the image elements 206 catch fire and are reduced to ashes.

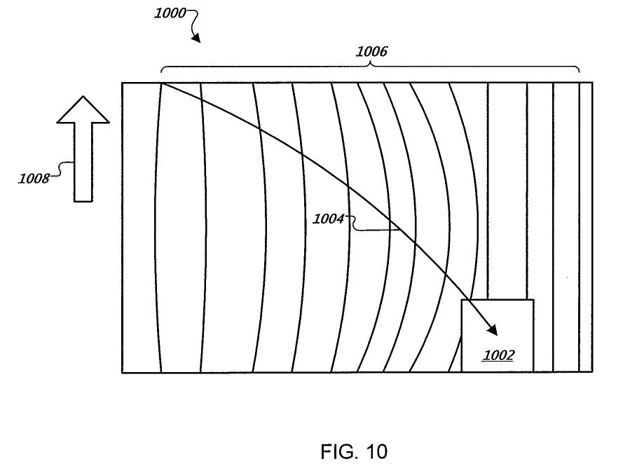

FIG. 10 is a screenshot 1000 of an example animation using touch screen-based trigger element 1002, a displacement animation effect, and image-based image elements 1006. In this example, a user's hand can be used to position or otherwise control trigger element 1002 to animate image elements 1006 on a touch screen. For example, as the user moves their hand over the touch screen, as illustrated by the path 1004, trigger element 1002 comes in contact with the image elements 1006. In response, the image elements 1006 can be animated by a displacement animation effect. For example, image elements 1006 can be a collection of animated arcs of electricity moving out of view (e.g., corresponding to the movement represented by arrow 1008). As the trigger element 1002 touches the image elements 1006, the image elements 1006 are displaced with a displacement animation that can be used to generate a vibration animation or other animations corresponding to the parameters provided by the trigger element 1002. For example, as the trigger element 1002 moves across the view, X and Y coordinates corresponding to the location of the trigger element 1002 can be used to determine if images elements 1006 have similar or identical X and Y coordinates. If the trigger element 1002 and the any of the image elements 1006 share similar X and Y coordinate, the animation effect is triggered. In other implementations, different image elements, animation effects and/or trigger elements can be used. For example, the animation effect can be to cause visible strings to vibrate, analogous to the strings of an instrument.

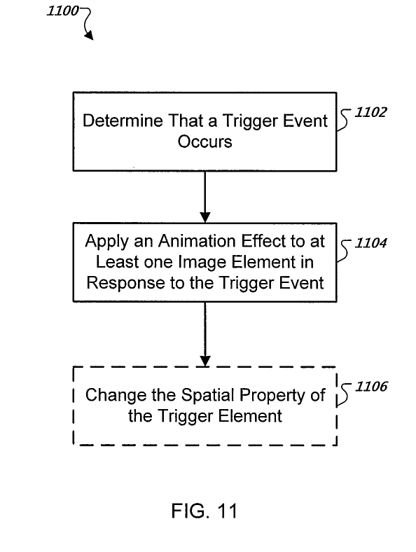

FIG. 11 is a flow chart of a method 1100 for animating an image element. In general, the method 1100 can be executed on a hand-held device, desktop computing system, or other computing system, to name a few examples. The method 1100 can be performed by a processor executing instructions in a computer-readable medium. In short, method 1100 illustrates performance of animations such as those described in the above examples with reference of FIGS. 2-10.

In step 1102, the computing system determines that a trigger event defined by a trigger element occurs. For example, in reference to FIG. 1, a trigger element 102 that comes into contact with image elements 106a-106n generates a trigger event. As another example, a random occurrence or an elapsed time may generate a trigger event.

In step 1104, the computing system applies an animation effect to at least one image element in response to the trigger event. In general, a first association (e.g., association 100A) between the animation effect and the image elements is configured for any animation effect to be selectively associated with the image elements. For example, any of a blurring, a magnification, a sorting, a displacement, a simulation, or other animation effects can be selectively associated with the image elements. In addition, a second association (e.g., association 100B) between the trigger element and the animation effect is configured for any trigger element to be selectively associated with the animation effect. For example, different geometric triggers (e.g., a circle, a square, a line, or other geometric shapes) can be selectively associated with the animation effect.

In optional step 1106, the spatial property of the trigger element can be changed. For example, a user can increase or decrease the size of a circular trigger element. By changing the spatial property, the number of image elements that are touching the trigger element may change. In some implementations, the spatial property can be a rate of change or speed of movement. For example, the speed the a line trigger moves across the view can be modified.

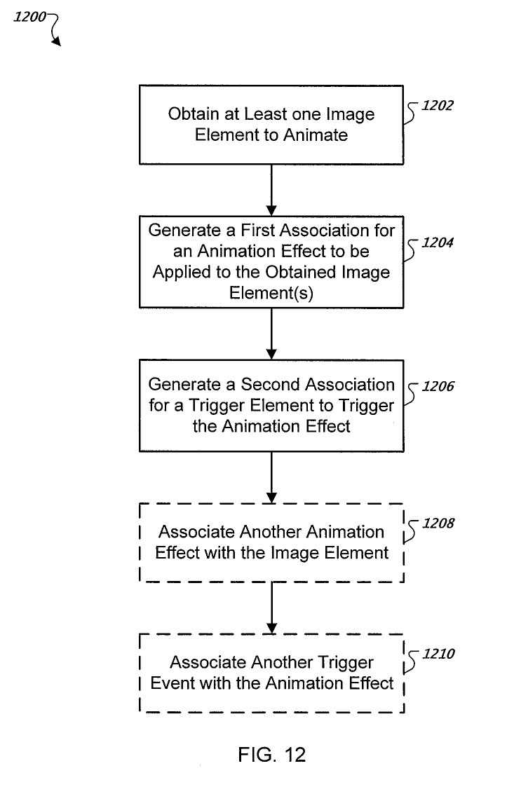

FIG. 12 is a flow chart of a method 1200 for providing animation of an image element. In general, the method 1200 can be executed on a hand-held device, desktop computing system, or other computing system, to name a few examples. The method 1200 can be performed by a processor executing instructions in a computer-readable medium. In short, method 1200 illustrates that trigger elements and/or animation effects can be freely associated in a combination that involves one or more image elements. It also illustrates the flexibility and interchangeability of trigger elements and/or animation effects in such combinations.

In step 1202, the computing system obtains at least one image element to animate. For example, a user can specify one or more image elements to animate that are stored in the computing system.

In step 1204, a first association (e.g., association 100A) is generated for an animation effect to be applied to the obtained imaged elements. In general, the first association is configured for any animation effect to be selectively associated with the obtained image elements. For example, a displacement, a magnification, a reshuffling, simulations, and other animation effects can be selectively associated with the obtained image elements.

In step 1206, a second association (e.g., association 100B) is generated for a trigger element to trigger the animation effect. In general, the second association is configured for any trigger element to be selectively associated with the animation effect. For example, a geometric shape, a random list, an ordered list, or other trigger elements can be selectively associated with the animation effect.

In optional step 1208, another animation effect can be associated with the image elements. For example, the current animation effect can be removed and replaced with another animation effect. As another example, in reference to FIGS. 9A-9D, a particle system is associated with the image elements 206, and another animation effect including simulating cinders, shrinking the image elements, generating smoke particles, and changing the coloring of the letters can be associated with the image elements 206. In some implementations, step 1208 can be executed multiple times, for example, in reference to FIGS. 9A-9D, multiple additional animation effects are associated with image elements 206.

In option step 1210, another trigger element can be associated with the animation effect. For example, the current trigger element can be removed and replaced with another trigger element. As another example, another trigger element can be associated so that either of them can initiate the animation effect. In some implementations, step 1210 can be executed multiple times, for example, in reference to FIGS. 9A-9D, multiple circular triggers 902b-902d are associated with the multiple additional animation effects that are associated with the image elements 206.

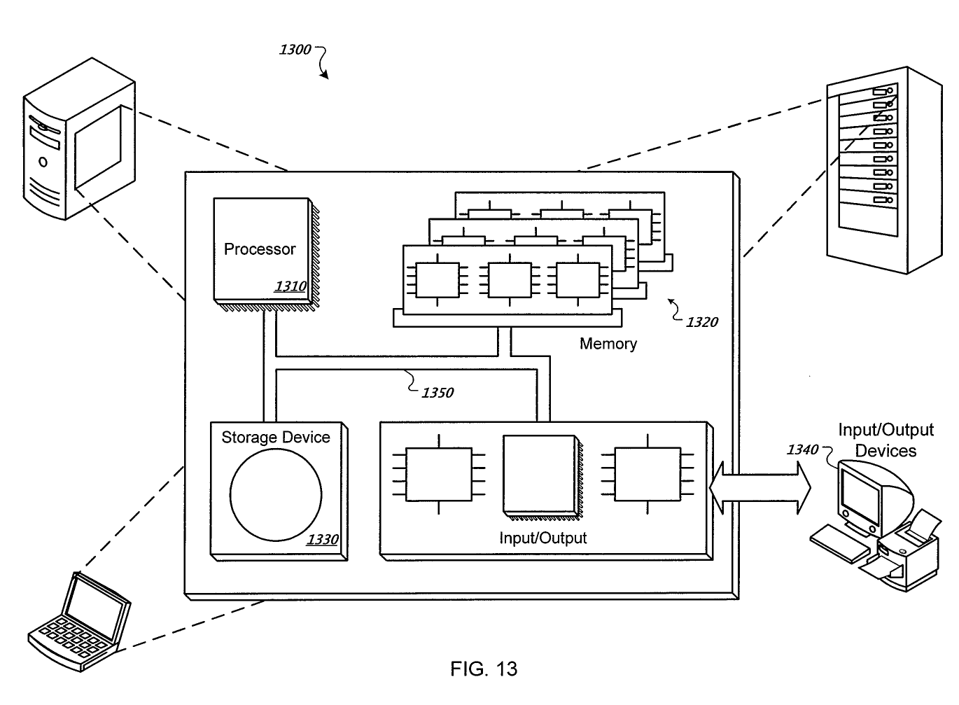

FIG. 13 is a schematic diagram of a generic computer system 1300. The system 1300 can be used for the operations described in association with any of the computer-implement methods described previously, according to one implementation. The system 1300 includes a processor 1310, a memory 1320, a storage device 1330, and an input/output device 1340. Each of the components 1310, 1320, 1330, and 1340 are interconnected using a system bus 1350. The processor 1310 is capable of processing instructions for execution within the system 1300. In one implementation, the processor 1310 is a single-threaded processor. In another implementation, the processor 1310 is a multi-threaded processor. The processor 1310 is capable of processing instructions stored in the memory 1320 or on the storage device 1330 to display graphical information for a user interface on the input/output device 1340.

The memory 1320 stores information within the system 1300. In one implementation, the memory 1320 is a computer-readable medium. In one implementation, the memory 1320 is a volatile memory unit. In another implementation, the memory 1320 is a non-volatile memory unit.

The storage device 1330 is capable of providing mass storage for the system 1300. In one implementation, the storage device 1330 is a computer-readable medium. In various different implementations, the storage device 1330 may be a floppy disk device, a hard disk device, an optical disk device, or a tape device.

The input/output device 1340 provides input/output operations for the system 1300. In one implementation, the input/output device 1340 includes a keyboard and/or pointing device. In another implementation, the input/output device 1340 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method for animating an image element, the method comprising:
determining that a trigger event defined by a trigger element occurs; and
in response to the trigger event, applying an animation effect to a group that comprises at least one image element, wherein a first association between the animation effect and the group is configured for another animation effect to selectively be associated with the group, and wherein a second association between the trigger element and the animation effect is configured for another trigger element to selectively be associated with the animation effect.

2. The computer-implemented method of claim 1, wherein the image element is at least one of: an image of an object, a character, and combinations thereof.

3. The computer-implemented method of claim 1, wherein the trigger element lacks spatial properties and comprises information configured to feed a parameter to the animation effect regarding the image element.

4. The computer-implemented method of claim 3, wherein the information is contained in at least one of: a numerical list, an alphabetical list, a random list, an amplitude of audio, input generated using an input device, input generated using a touch screen, and combinations thereof.

5. The computer-implemented method of claim 1, wherein the trigger element has at least one spatial property and is configured to feed a parameter to the animation effect regarding the image element, the trigger element triggering the animation effect upon touching the image element.

6. The computer-implemented method of claim 5, wherein the trigger element is one of: a geometric figure, a circle, a line, an animated sequence, and combinations thereof.

7. The computer-implemented method of claim 5, wherein the trigger element comprises a standard zone that causes the animation effect to be applied, and a dropoff zone that causes the animation effect to be applied to a lesser degree than in the standard zone.

8. The computer-implemented method of claim 5, further comprising changing the spatial property.

9. The computer-implemented method of claim 8, wherein the changing spatial property is one of: a shape changing size, a moving line, and combinations thereof.

10. The computer-implemented method of claim 8, wherein the spatial property changes in response to a user manipulating the spatial property.

11. The computer-implemented method of claim 1, wherein the group includes multiple image elements that are currently in an ordered state, and wherein applying the animation effect causes each of the multiple image elements to undergo motion away from the ordered state.

12. The computer-implemented method of claim 11, wherein the motion is one of: motion with inertia applied to the multiple image elements, and motion without inertia applied to the multiple image elements.

13. The computer-implemented method of claim 1, wherein the animation effect causes the image element to rotate.

14. The computer-implemented method of claim 1, wherein the animation effect comprises a wind effect that gives an appearance of blowing on the image element.

15. The computer-implemented method of claim 1, wherein the animation effect comprises a fire effect that gives an appearance of burning the image element.

16. The computer-implemented method of claim 1, wherein the animation effect causes one of: a size of the image element to change, a color of the image element to change, and combinations thereof.

17. The computer-implemented method of claim 1, wherein multiple animation effects are associated with the group, each of the animation effects having a particular trigger element.

18. A computer program product tangibly embodied in a computer-readable storage medium and comprising instructions that when executed by a processor perform a method for animating an image element, the method comprising:
determining that a trigger event defined by a trigger element occurs; and
in response to the trigger event, applying an animation effect to a group that comprises at least one image element, wherein a first association between the animation effect and the group is configured for another animation effect to selectively be associated with the group, and wherein a second association between the trigger element and the animation effect is configured for another trigger element to selectively be associated with the animation effect.

19. A computer-implemented method for providing animation of an image element, the method comprising:
obtaining a group comprising at least one image element that is to be animated;
generating a first association for an animation effect to be applied to the obtained group, the first association being configured for another animation effect to selectively be associated with the obtained group; and
generating a second association for a trigger element to trigger the animation effect, the second association configured for another trigger element to selectively be associated with the animation effect.

20. The computer-implemented method of claim 19, further comprising:
associating the other animation effect with the obtained group, wherein the other animation effect is to be triggered at least by the trigger element.

21. The computer-implemented method of claim 19, further comprising:
associating the other trigger element with the animation effect, wherein the animation effect is to be triggered at least by the other trigger element.

22. A computer program product tangibly embodied in a computer-readable storage medium and comprising instructions that when executed by a processor perform a method for providing animation of an image element, the method comprising:
obtaining a group comprising at least one image element that is to be animated;
generating a first association for an animation effect to be applied to the obtained group, the first association being configured for another animation effect to selectively be associated with the obtained group; and
generating a second association for a trigger element to trigger the animation effect, the second association configured for another trigger element to selectively be associated with the animation effect.
